(19) United States
(12) Patent Application Publication
(10) Pub. No.: US 2008/0177562 A1
(43) Pub. Date: Jul. 24, 2008

(54) Graphically Representing Consumers' Profiles

(76) Inventors: Javana Maithriya Gamunu Dias, San Jose, CA (US); Michael Joseph MacIntosh, Monte Sereno, CA (US)

Correspondence Address: RICHARD M. GOLDBERG, 25 EAST SALEM STREET, SUITE 419, HACKENSACK, NJ, 07601, US

(21) Appl. No.: 12/017,731

(22) Filed: Jan. 22, 2008

Related U.S. Application Data
(60) Provisional application No. 60/885,949, filed on Jan. 22, 2007.

(51) Int. Cl. G06Q 99/00

(52) U.S. Cl. 705/1

(57) ABSTRACT

A method of graphically representing a personal profile for a consumer, includes the steps of identifying a plurality of categories, in which a major variable representing the appropriateness for the consumer of each category may be given a numerical value; allocating a colored block for each of the categories, wherein each allocated color is defined by three color variables; modifying one of the color variables in response to the numerical value of the respective major variable; and arranging the colored blocks on at least one axis with respect to how the categories are measured against an attribute.

### CROSS REFERENCE TO RELATED APPLICATIONS

This application claims priority from U.S. Provisional Patent Application No. 60/885,949 filed 22 Jan. 2007, the entire disclosure of which is incorporated herein by reference in its entirety.

### FIELD OF THE INVENTION

The present invention relates to a method of graphically representing a personal profile for a consumer. The present invention also relates to a method of defining a peer group of consumers and to a method of conducting an online search.

### BACKGROUND OF THE INVENTION

The Internet is used to obtain information and to provide support with respect to many real world transactions. However for any individual, the ability to obtain information via the Internet does become restricted by existing popular search engines. However, due to the proliferation of the information available via the World Wide Web and the need for the search engine providers to show ongoing web new growth, there is an obligation placed upon them to the effect that the information returned is biased towards those who pay the most to reach a given audience.

In addition to merchants offering services, there is a spectrum of reliability, honesty and trustworthiness amongst them and there is no accepted standard system that will allow an individual to see where any merchant will fall within that spectrum. However with an increasing number of online transactions and the easy availability of downloadable records from banks, credit card companies and telephony providers, a situation has developed in which individuals are able to track their own behaviours and therefore make recommendations based on their personal experiences of merchants, both online and offline.

### BRIEF SUMMARY OF THE INVENTION

According to an aspect of the present invention, there is provided a method of graphically representing a personal profile for a consumer, comprising the steps of identifying a plurality of categories, in which a major variable representing the appropriateness for said consumer of each said category may be given a numerical value; allocating a colored block for each of said categories, wherein each allocated color is defined by three color variables; modifying one of said color variables in response to the numerical value of the respective major variable; and arranging said colored blocks on at least one axis with respect to how the categories are measured against an attribute.

### BRIEF DESCRIPTION OF THE SEVERAL VIEWS OF THE DRAWINGS

FIG. 1 shows an example of an environment in which the present invention may be employed;

FIG. 2 investigates an example of a registration screen;

FIG. 3 shows an example of a web history;

FIG. 4 shows an example of a graphical representation of a personal profile for a consumer;

FIG. 5 shows an example of the definition of PO Groups;

FIG. 6 illustrates a method of conducting an online search according to a refined procedure;

FIG. 7 shows an example of a search screen displayed to an initiating consumer; and

FIG. 8 shows an example of refined results supplied to an initiating consumer.

### DESCRIPTION OF THE BEST MODE FOR CARRYING OUT THE INVENTION

It is known that direct marketing is experiencing a pattern of diminishing returns and markets face a constant struggle to raise their brand or product above the general level of noise. However, as soon as they come up with an innovation that is successful, in doing so they will raise the general level of the noise and reduce the overall effect further. Furthermore, the low cost of communication created by the Internet generally tends to exacerbate this problem.

The present applicant believes that marketing can be radically reengineered by reversing the process. Thus, instead of the marketer making general approaches to large numbers of people about whom they know very little, an improved situation would be to allow the people, ie the consumers who want a product, to be found by the marketer when and only when they are ready to receive a proposition. The system relies on the availability of reliable information of each individual consumer and this will allow the merchant to make an approach that is both timely and relevant.

Past behaviour and future aspirations provide a reliable way to evaluate potential consumers, particularly if the consumer has indicated that they want to be propositioned. A current solution to this problem uses approximations based on purchased or collected data from large sampled populations. Consumer relationship management systems maintain large repositories of transactions and research data and this is used to segment the market into consumers who exhibit similar behaviours. The assumption is a good segmentation exercise and will produce a list of potential consumers with a high density to purchase. These segments are used to make an approach to the consumer but the response percentage rate is usually very low such that this may be a costly exercise in financial terms. Furthermore, it swamps at least 90% of the target audience with unwanted communications which in turn may lead to an eroding of the brand value.

For the existing marketing mechanisms to be improved, a number of barriers need to be overcome. Firstly, data is often unavailable. That is to say, the detailed data that underlies an individual's wants, needs and preferences, or how they go about purchasing etc is simply not available to the marketers. People do not document their needs. However, this knowledge can be deduced from the sequence of activities that precede a purchase. For example, Internet shopping leaves a browser history log that will permit information to be inferred therefrom.

Data tends to be distributed. Thus, the detailed transactions and activity from exercises such as banking, credit card usage, browser usage and shopping purchases, such as that obtained from consumer loyalty systems, are stored in the databases of each of the individual providers. Little of this information is available, although with data standards across systems and data trafficking by the consumer analysis providers, this information is increasingly becoming joined up. However, controls do exist in terms of the extent to which this information may be used without permission.

Data tends to be inconsistent in that the information is held in different formats with different attributes, characteristics, units and formats. This makes use of the data time consuming and generally difficult to process because each individual will have a unique set of data sources.

Data is often incorrect in that very often the data is out of date or its significance is unknown. This means that the marketer makes incorrect assumptions about the individual and therefore will select them as a target inappropriately and lower the return of any marketing expenditure. The present approach looks to propose a formula in which a function is derived based on assumed demographic data that may be considered core data, in addition to transactional data based on actual transactions and in addition to preference data, that is data positively defined by the consumer themselves.

The result is a behavioural profile that is designed as a standard format that can be generated from any data that is available in electronic form. It will describe the behaviour of any individual in an identical way by encoding distributed data using a standard algorithm, accounting for significance and relevance. This encoded data can be interpreted in a standard way that will allow a marketer to draw the conclusions that they require.

The approach of taking the available data, performing a calculation based on certain data elements within it and producing an output that is an encoded result that can be decoded is a process that is repeatable and will yield a consistent result across a population of individuals. It is therefore possible to say that the process is repeatable.

Additionally, as there are an infinitely large number of differences that can be drawn from a rich set of data sources, the preferred methods can be extended to create behavioural profiles from new behaviours as yet undefined and as such it may be referred to as extensible.

The behavioural profile element for a marketing question defines a standard computation that provides three scores between values of 1 and 255. The most significant score would be used to set the hue with the next being used to set saturation and the final one being used to set luminosity. Thus, the most significant score has been identified as a major variable with the others being identified as minor variables. Thus, a color will be defined that can be visually compared. That is, a person will, be able to view two behavioural profile elements or categories side by side and compare if they have similar colors. Thus, it is easy to see whether the elements are the same color or are as bright as each other. It would be possible to achieve greater accuracy using actual computational scores but the method of using colored blocks provides a fast approximation to the marketeer and thereby allows a larger volume of data to be considered in any particular operation by relatively unskilled operatives.

There are a number of standard questions that the behavioural profiles will address. When these behavioural profiles are encoded into their colored blocks they can be combined into a pattern of blocks. Initially based on a set of standard questions, the blocks are arranged onto three, three by three (3×3) squares. Each square has a pre-set arrangement of blocks representing the questions, with progression from left to right representing time (left-most being now and right-most being long term) and a verticals axis representing perspective (the bottom representing local and the top representing global). Using position in this way for the attributes it becomes relatively straightforward for the consumer to analyse the complete profile of two consumers by comparing the position of the squares within the totality of the display.

Once the behavioural profile has been encoded, it becomes a relatively small data set, requiring little overhead when being transported across networks. Thus, the individual profile for individual consumers requires very little storage and transportation bandwidth. The standard description of how the data is constructed needs to be transferred only once for all individuals whose behavioural profiles are being communicated. The source data does not need to be transferred, allowing for a very lightweight marketing data transfer protocol to be developed.

The source data for this calculation will remain on the consumer's machine entirely under the control of the consumer. The marketing data profile is computed locally on the consumer's machine and is made available only at the information owner's (ie the consumers) request. The raw source data and the colored profile blocks are encrypted using a private/public key system to ensure controlled and selective access.

The consumer's raw data is acquired with the consumer's permission and retained locally. Raw data sources include browser history, and loaded bank activity statements, downloaded credit card activity statements, mobile phone usage statements, landline usage statements, downloaded utility bills and similar financial transactions. The data source would be verified and that verification built into the local archive.

Further data is obtained for a particular consumer by accessing reference data. Reference data, maintained centrally, includes merchant files and outlet files, that is to say documents that any merchant that the system or community transacts with along with demographic graphic data including that obtained from standard research processes, including information about gender, age, location and job type etc.

Inferences are made of an individual based on an analysis of the raw data while applying rules and additional information from reference data. If a merchant appears repeatedly in a consumer's transaction history, the volume and value of activity of that merchant would be rated. The reference files are then used to determine more detail about the merchant and this detail is represented in the inferences.

The consumer is represented with the inferences and within this presentation the consumer is asked to enhance the data by specifying significance. That is to say how far they agree with the inferences that have been made. The data is then encoded using a method of codification that could be applied universally to all individuals with a variety of data sources. It takes multiple data sources and applies a set of questions, each of which requires certain elements found within the data to determine the answer. It then takes the answer and expresses it as three values plus certain key words. The addition of further data sources can be accommodated by drawing out further information with which to answer the questions.

When the data is shared it is transmitted to a central server with an authorised code such that the consumer of the data (most frequently the marketer) is only able to see the data with the prior permission of the individual consumer. The data can be decoded automatically or interpreted manually to serve the purpose of matching an individual with goods and/or services for which they may have expressed an interest. A central server will hold the definition of the data along with how it should be decoded or interpreted. When new questions are generated, the central server is able to update the local application on the individual's machine that will cause new profiles in response to the question to be generated and transmitted. If a new data source becomes available from the individual, they will be able to request a template from the central server to allow that data source to be included in the raw data. Operation of the system is summarised as follows.

First, a consumer registers with the service as a member and is asked to provide basic details about their age, household, employment and location—all details are optional—this goes to form the Core Data.

The consumer then downloads a client-side Agent as a Java browser plug-in for Mozilla or Active-X MSIE etc.

Download templates for bank accounts/credit card/or other accounts whose data will be imported.

Use Agent to log into account and perform download to locally held CSV format that is automatically imported into the system database—the import process will also include compression and encryption using standard methods.

The Agent will compute a check-digit based on the downloaded data and the login credentials and timestamp to record the validity of the actual transactions. A validation code is thus computed.

The consumer can perform manual validation of data and tag specific transactions with a significance rating from 0-10 (0 being hide completely to 10 which is highly significant.

The Agent also imports browser history from consumer's browser (MSIE/Mozilla) and places this into the database—the consumer is able to remove history that they want to remain private.

The Agent weights the browser history, attaching greater significance to the last 2 weeks' data, less to the last 3 months and even less to the last 12 months. Anything prior to that is low significance but not discarded.

The Agent then performs a frequency count of what sites were visited—with the weighting factor included

For each browser history grouping, the Agent looks to external sources and uses the base URL to see how other consumers have tagged the site.

The Agent builds a cumulative list of tags for the top 20% of sites, for the next 30% of sites and finally the last 50% of sites.

The Agent then takes the merchant from each browser or financial transaction and matches it to merchants in the merchant file (that can be held on the server side database). It will then take the tags applied to each merchant and consolidate those against each transaction that will the consumer to augment the profile.

The Agent builds a profile that is transaction and profile based and this is presented to the consumer—as 3 tag clouds (based on the 20:30:50 behaviors) and as a series of 27 colored squares, the HSL (Hue Saturation Luminosity) value of any square representing the profile score (see section 4.2, Colored Profile Square Representations).

The consumer is able to further augment their profile with tags, preferences and requests for information (prior to purchase). This will be incorporated into a set of searchable keywords that will always accompany the consumer's profile. The consumer's profile will also be augmented by a validation code as computed above.

Finally, the consumer profile data will be bundled and transmitted at their request to the server side component where it is held against the consumer's id. The consumer will be able to repeat any of the preceding steps to refresh their available profile.

Ultimately, new questions could be formulated based on what the marketer needs to know and what data is available. The process could be reversed by performing cluster analysis on the data to understand shared behaviors and thus creating a question that would elicit the responses obtained.

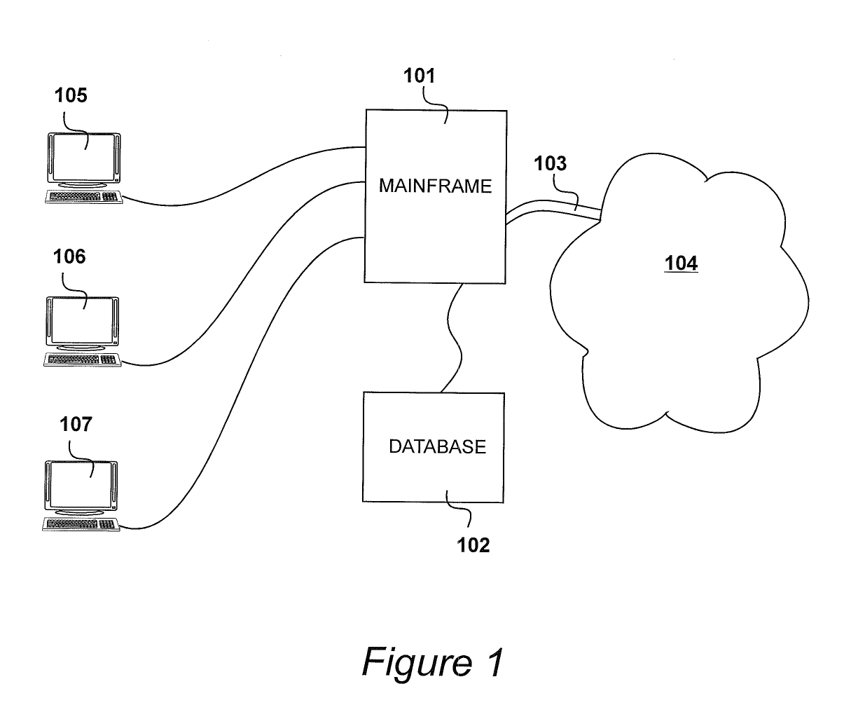

### FIG. 1

An example of an environment in which the present invention may be employed is shown in FIG. 1.

A main frame computer 101 is maintained that has access to a large local storage device or database 102 and a connection 103 to an external network 104 which, for example, could be the Internet.

Personal information is received from consumers via terminal devices 105,106 and 107.

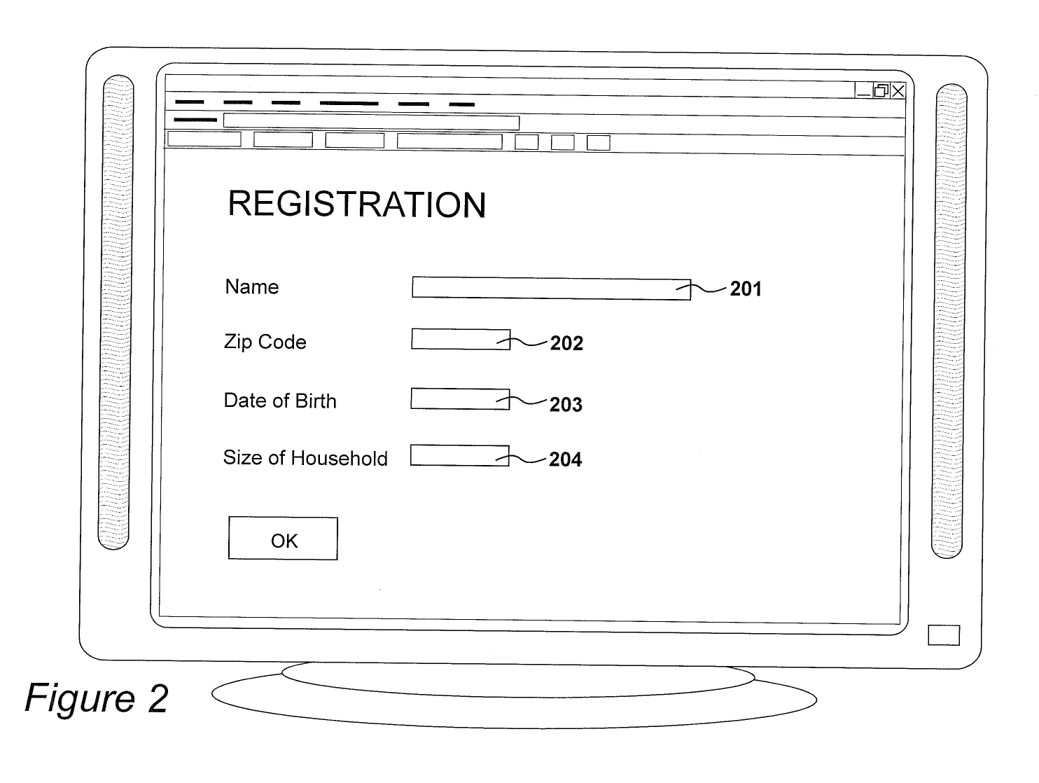

### FIG. 2

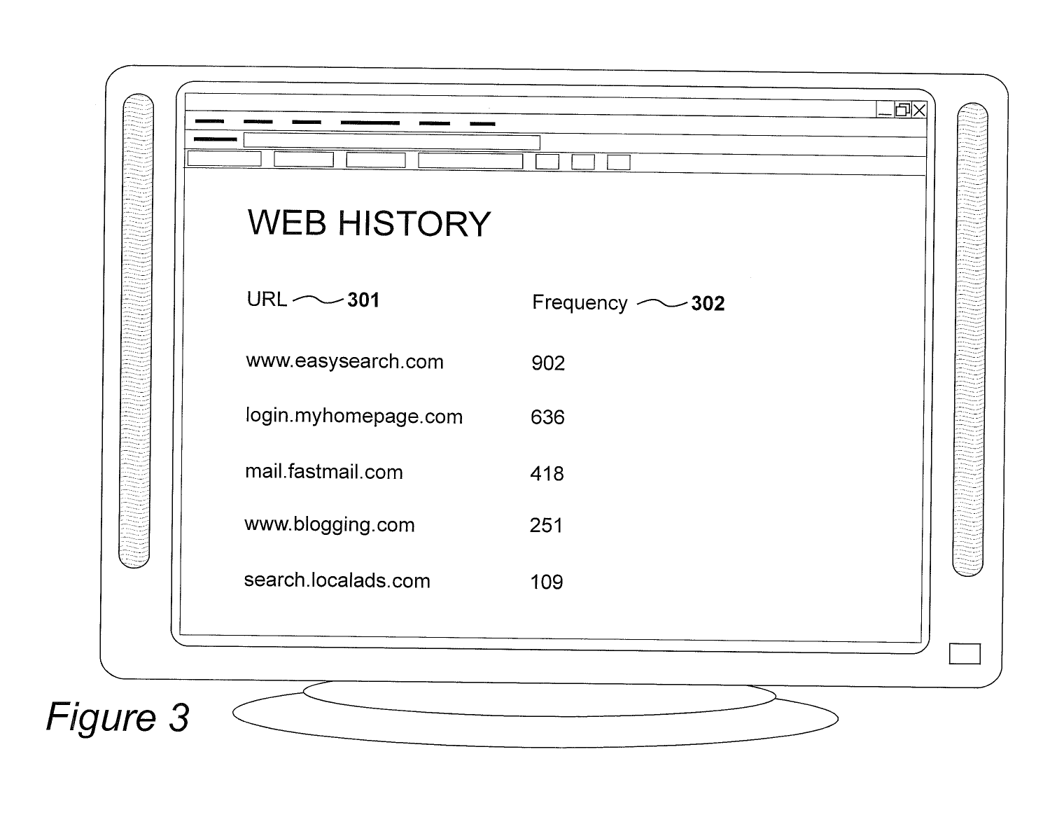

An example of a registration screen is shown in FIG. 2. A consumer is able to enter information such as their name at 201, ZIP code at 202, date of birth at 203 and size of household at 204. Various combinations of information may be requested but generally only basic facts are required at this stage. Further information concerning a consumer's personal profile is obtained from other sources such as the example given in FIG. 3.

### FIG. 3

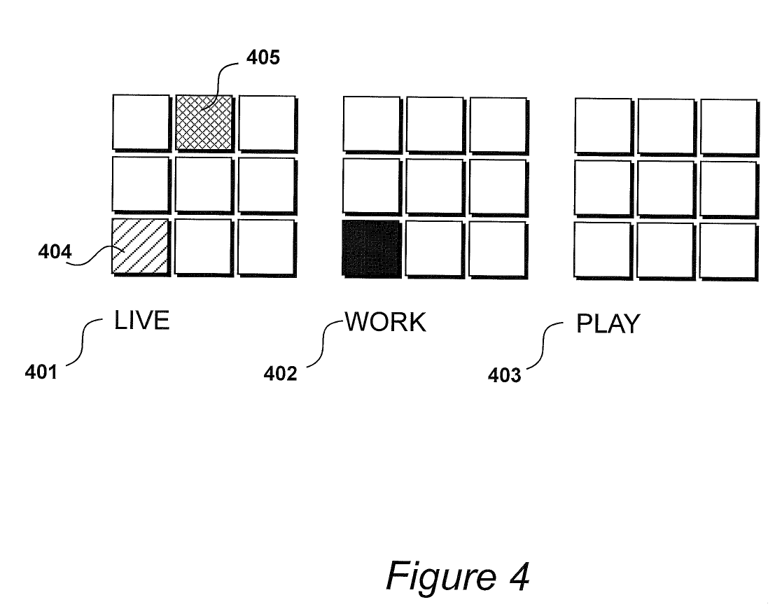

An example of a web history is shown in FIG. 3. A series of universal resource locations (URLs) are listed at 301 along with the frequency of visitation at 302. In addition to obtaining information via registration as described with reference to FIG. 2 and web history as shown in FIG. 3, further sources of information such as transaction details, assumed demographics relating to research about a population sample, preference data obtained in response to questions asked of a consumer or many other methods may be used in order to build up a personal profile. The personal profile may then be represented graphically as is further described with reference to FIG. 4.

### FIG. 4

An example of a graphical representation of a personal profile for a consumer is shown in FIG. 4. A plurality of categories are identified within three fields. In this example the fields “live” at 401, “work” at 402 and “play” at 403. Within each filed, a plurality of categories are identified. Within each category, a major variable represents the appropriateness for the consumer of each category. The major variable may be given a numerical value. A list of examples of categories is provided below.

Each row in the table represents the answer to a particular question regarding the analysis subject's profile in three life aspects—Live, Work and Play (the vector—x, y, z—represents the position in the grid). These questions are currently a part of a hypothesis that suggests what data would be important to marketers.

| | | | |
|---|---|---|---|
| Live | What is my house | 1, 1, 1 | Type, size, location, style |
| Live | Do I take | 1, 1, 2 | Am I cautious - do I over insure, do I |
| | precautions | | bend the rules |
| Live | How do I invest | 1, 1, 3 | Am I planning for the financial future |
| Live | Where do I live | 1, 2, 1 | In what geographical location do I |
| | | | live my life |
| Live | Am I reliable | 1, 2, 2 | Do I pay up, settle my debts, do I do |
| | | | as I say |
| Live | What is my reach | 1, 2, 3 | What is my sphere of influence, |
| | | | work, friendships, media |
| Live | Am I on time | 1, 3, 1 | Do I pay my bills on time, do I work |
| | | | to a tight schedule |
| Live | What is my debt | 1, 3, 2 | Do I maintain a high level of debt, is |
| | | | it risky |
| Live | Do I value | 1, 3, 3 | Am I educated, do I continue to |
| | education | | learn, do I create learning |
| Work | How is my family | 2, 1, 1 | What is my marital status, childen, |
| | | | extended family importance |
| Work | What is my work | 2, 1, 2 | What type of job do I have, what is |
| | | | my pay |

As an example, the first line of the above list gives the information that within the field “live” a category is defined entitled “what is my house”. This category is represented by an allocated colored block. In this example, the “what is my house” category is represented by the block in position (1, 1, 1) (bottom left block shown in FIG. 2 as 404). The color of block 404 is defined by three color variables. An example of these are hue, saturation and luminosity. One of these color variables is modified in response to the numerical value of a major variable within this category. Therefore, a color space is created representing variation in the category “what is my house” and the position of the consumer within this color space is represented by the color of block 404. As an example, the hue of box 404 (positioned at (1, 1, 1)) could be amended according to the following parameters within the category “what is my house”: if rented add 0, if owned add 125, if house boat add 40, if multiple homes add 5 etc. A large number of these parameters may be provided and the hue is modified. In further examples other color variables could be modified in response to the numerical value of the respective major variable. Thus a value for hue is calculated and block 404 rendered appropriately.

In addition to the major variable defined by parameters such as those described above, minor variables may also be identified. For example, the saturation of color may be modified in response to how long the consumer has lived at this house. For example, if the last move was more than 40 years ago add 25, if last move was less than 10 years ago add 50, if last move was less than 5 years ago add 75 etc. Thus the saturation of color of box 405 may be amended by the numerical value of this minor variable relating to duration of residence.

A further minor variable may modify a further color variable such as luminosity. For example in accordance with the following parameters: if the house setting is rural add 25, if in a small town add 50, if suburban add 75, if city centre add 100 etc. Thus the luminosity of block 404 may be modified in response to the minor variable relating to location.

In addition to the modification of color variables in response to the numerical value of a major variable (and in this example minor variables) the colored blocks are arranged on at least one axis with respect to how the categories are measured against an attribute. Thus in this example, block 404 is positioned at (1, 1, 1) in accordance with how the category “what is my house” is measured against an attribute.

As a further example, block 405 represents “what is my reach”. It is arranged within the field of “live” and the category “what is my reach” is placed in position (1, 2, 3) in relation to the measurement of the category “what is my reach” against an attribute. The color of block 405 is modified in relation to a series of parameters. The hue is modified in response to the numerical value of a major variable and, in this example, the saturation and luminosity are modified in response to the numerical value of minor variables.

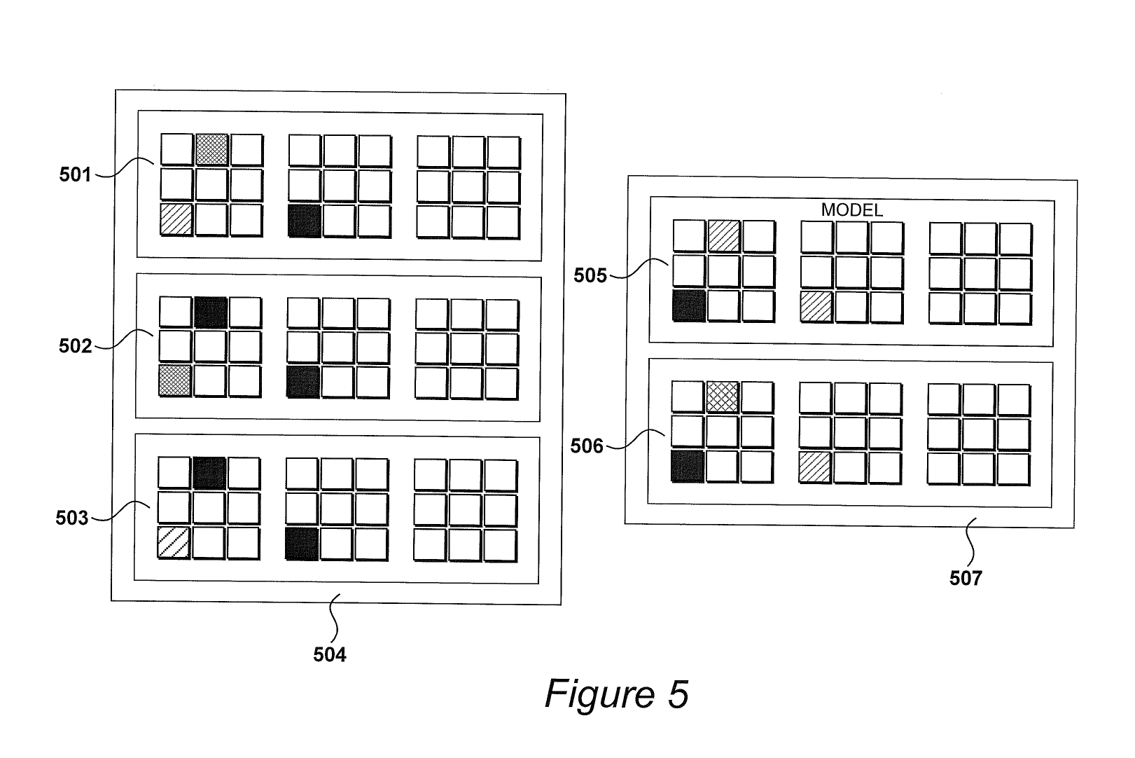

### FIG. 5

When a marketer has a proposition, either a product, service, location or any combination of these, to increase the return on their investment, they have an objective of making as many sales as possible. To do this they must generate awareness and then convert interest into sales. Most if not all organisations satisfy the budget to do this therefore efficiency of the marketing activity is important. Money is wasted in marketing to individuals who are not predisposed to purchase, therefore it is in the interest of the marketers to spend their money and energy on marketing to those who are most likely to buy.

Segmentation techniques are today being replaced with consumer relationship management concepts where an organisation is more able to gain a single view of that consumer across all of its interactions. One to one marketing is the practice that has been enabled like this where armed with the knowledge of the individual that has been gained by mining all available information within the organisation, any interaction with that individual can be made more relevant and appropriate thereby increasing the chance that the individual will purchase. Organisations have implemented systems to capture and centralise the information about their prospects and consumers and these feed data into the information systems.

The data available to any single organisation is usually limited so the breadth of interaction that the organisation as with the individual. Certain conglomerated companies will have a broader spectrum of most but more often than not that information is held in silos where it is difficult at best to join up data on any one individual.

Another method of other coming the lack of data is to either purchase the information from bureau's or to use a bureau to combine the data with data that has been acquired elsewhere. However, due to data protection laws in many countries, this practise is often illegal without the explicit permission of the individual. However, organisations are able to get around this problem using a technique known as umbilical cord combining of data where the actual data is never combined this attributes of two data sets are used to filter amidst the past characteristics specific to both sets.

Neither practice places any onus on the consumers themselves being able to specify their preferences or obtaining explicit permission. While the combination of data across the unique pattern of organisation that the individual transacts with is not considered. Therefore a completely accurate picture of an individual's habits will not exist in any machine-readable form.

The present proposal as identified by the applicant establishes a consumers profile that is held locally on the consumers machine. This is encrypted using the private-public key system. At the consumer's request the profile is uploaded into a central database and held there using the consumer's exclusive id.

It is considered desirable to match this consumer with others like them. This may be to create a set of consumers who all exhibit a similar behavioural trait to become a target audience for a marketing communication or to become a peer group who will receive information and recommendations from others. Thus, for the purpose of this disclosure, grouping of consumers with similar attributes will be referred to as a peer group.

Individual will select peers, when given a choice, based on personal knowledge and will probably select people whose opinions they respect. However, the present system will be selecting peers based on actual behaviours. The systems matching technique has been to trying to allow both methods to operate interchangeably, that is to say automatic grouping and consumer specified grouping. This is valuable as the system may select the peers based on matching behaviours but a person may want to analyse the group or to specify which behaviours the consumer is actually considered to be important.

The system will go through a population of consumers matching certain characteristics in the profile. They do this by clustering like consumers within a specified tolerance level or it may be given a model consumer to whom it is instructed to match.

As previously stated, this population is referred to as a peer group and consists of a set of consumers a set of consumer identities plus a model profile and tolerance level. Such a peer group will carry a unique peer group id which will have a unique date of creation associated with it. This peer group will exist as a record on database of peers on a central server.

Additionally, each peer in the group will be informed of its membership by receiving a notification from the local server. The local server will therefore maintain an up to date knowledge of all the peer groups that it is a member of.

There would be a peer group that the consumer is able to specify themselves with no further assistance from the system. This peer group may be used to augment or automatically computed peer groups should be used to desire.

An individual consumer is able to view their local raw data information in a variety of ways. One way would also be benchmarked against their peers. The system would select a sample of the consumer's peers and acquire the data to be benchmarked from each. The system would then perform an analysis and show the consumer's relative position or percentile against the set of peers.

In the preferred embodiment, the consumer's profile is encoded using 27×3 values between 1 and 255, where each value can be precisely calculated based on a transactional, core and preference data available.

The matching requires an implementation of an algorithm that will allow relative proximity to be determined. To start by looking at block (1, 1, 1) if the hue goes up, it signifies that the consumer is living in a larger more luxurious residence than that they own rather than rent. This will be apparent in the color change. If the saturation goes down, the consumer has moved more recently. If the whole block is lighter, the consumer lives in a larger accommodation.

This can be seen visually but can also be implemented as an automatic process using range criteria on the HSL values for each block. The values of the three variables can be specified and a certain tolerance range applied.

As a merchant uses the blocks to specify their target audience, they might choose to only specify parameters on certain blocks. This will mean that any value will be applicable to the other blocks. A system works along the following procedures.

The consumer's profile data will be bundled and transmitted at the consumer's request to the server component where it is held against the consumer's ID.

At some point the server will be holding a large number of profiles for consumers and it is from within this set that peers can be found.

Data from all 27 variables can be analysed and consumers can be clustered on similar patterns. A clustering algorithm will add extra weight to location (1, 2, 1) ie what is my reach and family situation etc and these factors are the most useful when setting up a peer group which can influence results when a search is performed.

An initial group of fifty consumers will be marked as peers for any one of said consumers. A consumer will be able to see the profile data (using some type of visual interface) to view the profiles of selected peers. The consumer will also be able to replace twenty-five of those peers the other consumers considered to be more appropriate by the consumer.

This set of fifty consumers should be reviewed on a regular basis, say every three months, to ensure that the peer group is still valid and significant.

Finally, merchants will select characteristics based on the twenty-seven questions and the system will construct a target population set based on a profile match within a specified variance. Offers will be presented to that population should they agree.

It is possible to identify potential consumers for this system in that a marketer has a specific promotion that they want to communicate to a certain audience. They will specify the criteria for the audience using a taxonomy provided by the system. This will include certain values and tolerance ranges. The system will return to them the number of results received, a distribution of how well that number of consumers fit profiles specified and a cost for reaching those individual consumers of a per response basis. The marketer can then amend the target population based on what they want to spend and how relevant the audience is ready to be. Once the target population has been specified, the merchant can then make their promotion to the audience. This will be done by presenting the offer to each consumer and if the consumer responds by clicking on the offer, the merchant will be charged a nominal fee. If the consumer chooses to identify themselves to the merchant and begin a dialogue, the merchant will be charged a larger fee. The money collected from the merchant will be passed to the consumer's account less an administration charge.

As described with reference to FIG. 4, a plurality of categories are identified and personal profiles for consumers are produced in accordance with the appropriateness of each category. Once these steps have been undertaken in relation to a plurality of consumers, peer groups may be defined in accordance with a method that will be described with reference to FIG. 5.

Numerical values are obtained based on consumer preferences and recording activities as previously described with reference to FIGS. 2 and 3 to produce a consumer profile. These consumer profiles may then be compared with respect to predefined tolerances. Consumers may therefore be grouped into peer groups in response to the comparisons made. In FIG. 5, a first consumer's profile is shown at 501, a second consumer's profile is shown at 502 and a third consumer's profile at 503. In this example, the profiles are represented graphically in accordance with the method described with reference to FIG. 4, but alternative methods of representation may be used and this example is for illustration only. The consumers to which profiles 501 to 503 relate have been placed into a peer group 504. This may be achieved by grouping together consumers with profiles that are similar. For example, consumers 501 to 503 have similar personal profiles and therefore have been grouped into peer group 504. Depending upon the configuration of the system, each peer group may have assigned a model profile and consumers may be allocated to a peer group if their profile is similar to the model profile to within a predefined tolerance level. An example of this is given at 505 where a model profile 505 and profile 506 which corresponds with a consumer falls within predefined tolerances of similarity to model profile 505, therefore it is allocated to peer group 507.

Thus, as a result of identifying a plurality of categories, in which a major variable representing the appropriateness for a consumer of each category may be given a numerical value, consumer profiles are produced. The numerical values are populated based on consumer preferences, recorded activities or from other sources in order to produce the consumer profile. A plurality of consumer profiles are then compared with respect to predefined tolerances relating for example to a model profile or to a required level of similarity between profiles. Consumers are then grouped into peer groups in response to the comparisons. A consumer may be allocated to more than one peer group. For example, a consumer may be allocated a peer group for each field into which categories fall, for example being in a first peer group for “live”, a second peer group for “work” and a third peer group for “play”.

In addition, a consumer may be allocated to peer groups which are subsets of each other. For example, a large peer group may be defined with a high level of tolerance, such that for example any consumer with a numerical value of between 0 and 200 for a given category is a member. A further peer group may be defined which is a subset of the first peer group, such that any consumer with a numerical value of between 0 and 100 for a given category is a member. A further peer group may be defined which is a subset of the first peer group, such that any consumer with a numerical value of between 0 and 50 for a given category is a member, etc. Thus, the third peer group is a subset of the second, and the second and third peer groups are subsets of the first.

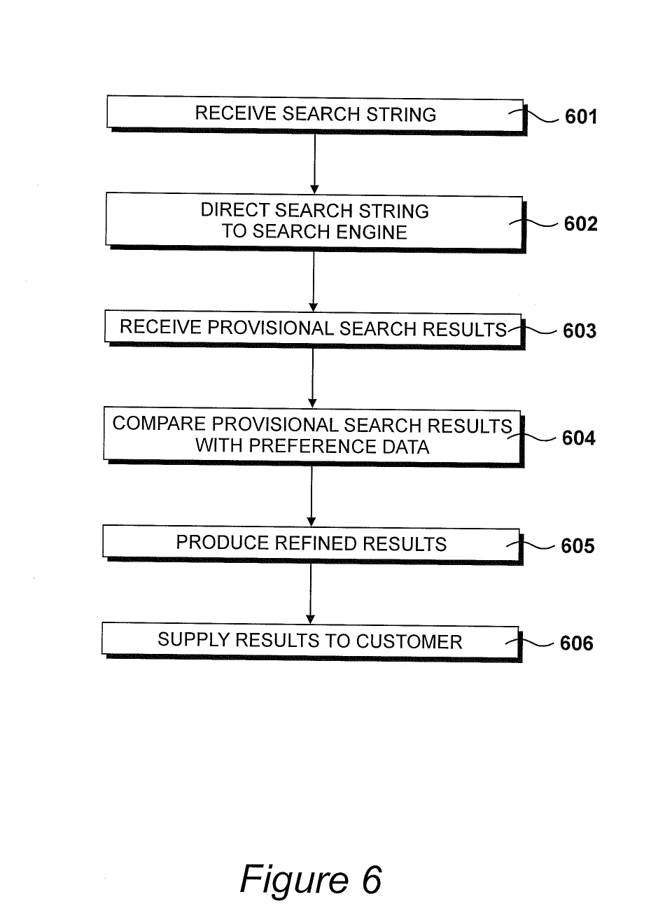

### FIG. 6

The online world and the offline world are two separate places, although an entity will have a presence in both domains. The larger the online world grows the more difficult it will become to locate resources on it and by the nature of commerce and capital markets, it will become a place where those advertisers and marketers who spend the most money will become the ones with the most significant presence, just like brands in the real world. This does not create a problem in the real world, because by looking hard enough or by taking personal recommendations, it is possible to find the places of merchants that do not spend a lot of money on brand promotion.

A manufacturer that invests in increasing the quality of their product and invests nothing in promotion will eventually find popularity through word of mouth. On the whole this means that page rank algorithms may place them higher but in a world where most places use commercial search engines whose revenue stream relies on advertising, they will be rated lower than manufacturers that invest all of their money in advertising rather than investing in terms of producing quality products.

The business problem considered is how to ensure that the opinion of a peer group counts for more than money spent on advertising. The internet is equipped to enable this by making available the collective opinions of those peers.

The popular search engines in use today have a variety of methods to determine which sites are most relevant to a particular search string. The page rank method that uses network popularity is most common.

Social networking engines are now being popular and using experiences of other consumers to rank sites. A combination of mining the experience of others and tagging is leading to sites appearing higher up the rankings than if they just received a lot of recommendations from others.

Most of the search engine providers are commercial companies and use advertising revenues to fund themselves. This may tend to compromise search results and as long search engines are funded in this way the situation is unlikely to change.

The social networking sites rely on the wisdom of crowds which seems to be more intelligent than any one individual but does produce a result that is in the best for the total of the crowd. This works overall however when a person is seeking something specific, the total crowd will not necessarily provide the best possible answer for that particular individual.

Thus, the problem remains of finding the most appropriate peer group for an individual.

The consumers profile is held locally on the consumer's machine and shared with a central server. This process is repeated periodically. A peer group for that consumer is build on the central server and the consumer identifies that peer group locally on their machine again this process is repeated periodically.

There may be multiple peer groups, one for each different aspect of the consumer's activity. When a consumer types a search string, the server receives the request and will use existing popular search engines to create a weighed average set of results, considered as being the provisional results of the search.

This provisional list is returned to the system and is also logged as part of the consumer's history. The provisional will be ranked once more by its popularity in the cumulative history file. The ranking algorithm will take in to account how recently a site has been found.

In addition, a notification, is sent out to all of a consumers peers, or the particular peer group considered appropriate. The notification will contain the search term and each peers machine will independently return a listing of sites of merchants that it has in its own local file history at matched term. If a merchant has appeared in a transaction file than it receives a higher rating than if a consumer has just browsed to it. The search results from the peer's machine will be returned to the original consumer's machine to augment the original listing.

The returned results from a consumer's machine will include websites that the consumer has browsed and thus represents websites of the merchants that appear in the transaction data and merchants without websites that have appeared on other types of transaction data. If the peer consumers machine is not available then there will be a time out period triggered and the original consumers machine will continue to poll that machine.

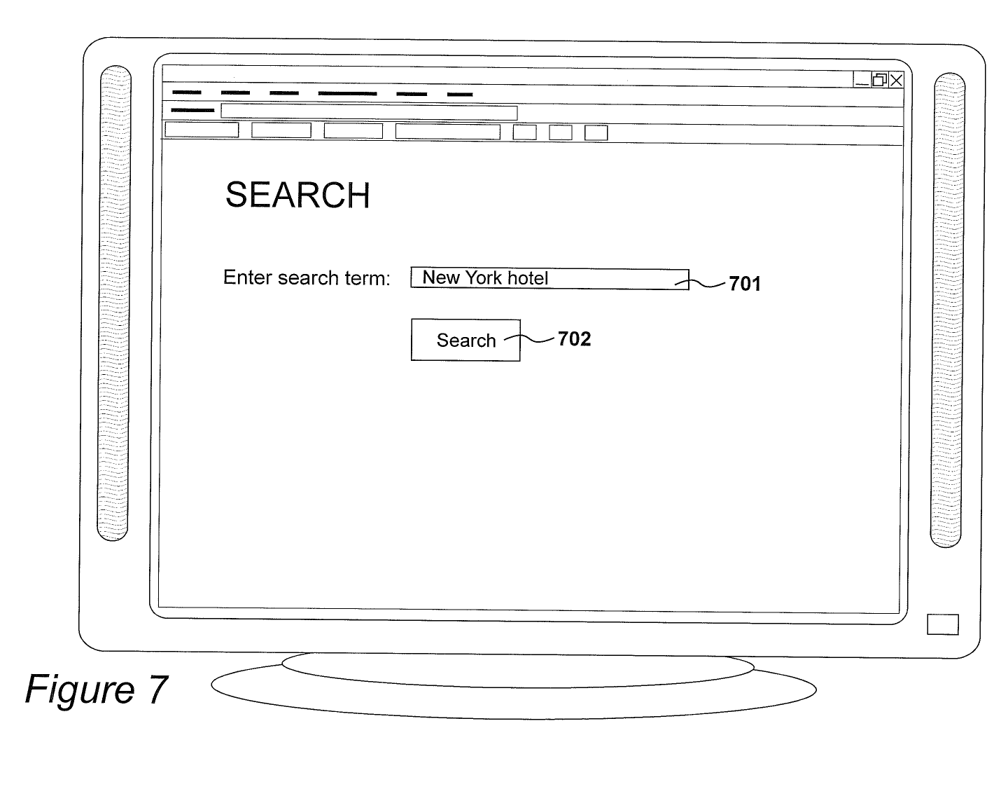

As a result of defining peer groups of consumers as described with reference to FIG. 5, preferences amongst a peer group may be used I order to refine online searching. A method of conducting an online search in accordance with this refinement is illustrated in FIG. 6. At step 601, a search string is received form a consumer. This step is further illustrated in FIG. 7.

At step 602, the received searched string is directed towards one or more commercially funded search engines. These search engines are typically provided by commercial companies which use advertising revenues to fund themselves. This means that the search results returned are compromised as higher rankings can be achieved by providing larger revenues. Therefore, the search results received from the commercial search engine or engines are treated as provisional. These results are received at step 603.

In the light of the peer grouping exercise performed as described with reference to FIG. 5, the provisional search results received at step 603 can be compared with preference data at step 604. Depending upon the configuration of the system, results which have been highly sponsored may be automatically removed. In addition, statistics may be obtained from comparing the experience of consumers from the peer group of the initiating consumer. Thus, search results frequently selected by members of the initiating consumer's peer group may appear higher as a result of step 604 when the refined results list is produced at step 605. At step 604 at which the provision of search results are compared with preference data, more weight or influence may be given to consumers who are co-members of a smaller peer group with the initiating consumer.

An example of a method of performing this would be to calculate a weighted average of experience such that the more closely related a consumer is to the initiating consumer the more influence their experience has in producing the refined results.

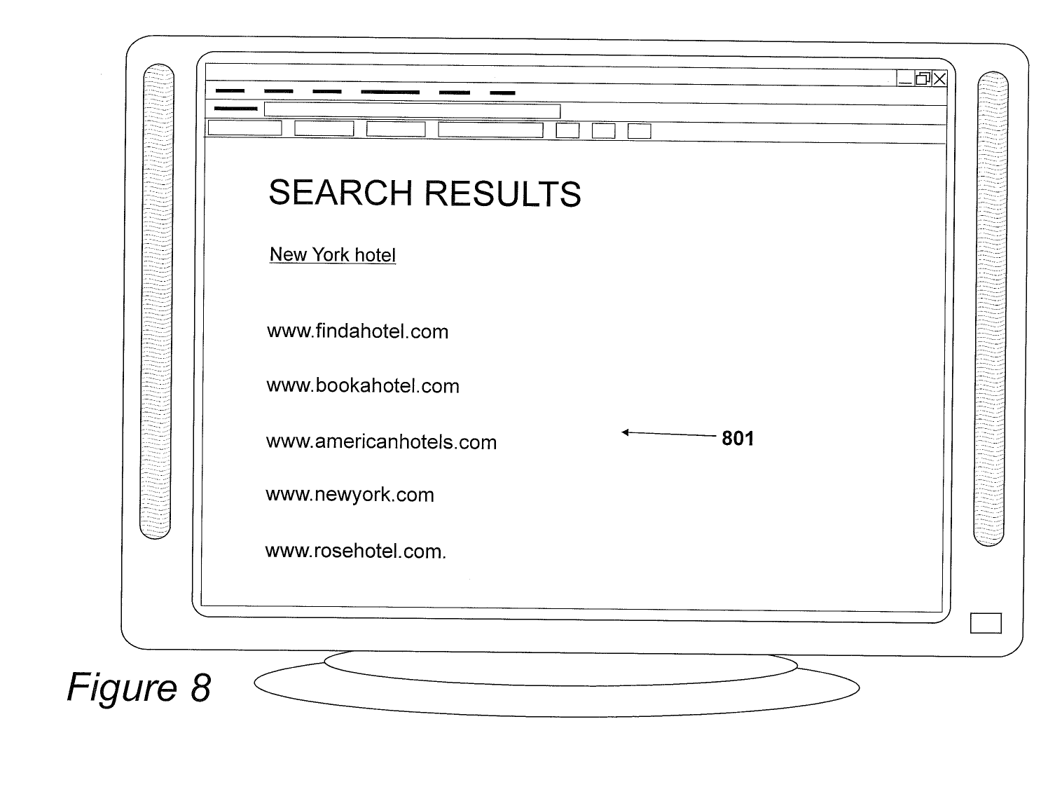

The refined results are supplied to the consumer at step 606, as is illustrated in FIG. 8.

### FIG. 7

An example of step 601 at which a search string is shown in FIG. 7. A text box 701 is provided to which an initiating consumer is able to enter a search term. A button is provided at 702 for the initiating consumer to press once they have entered their search term.

### FIG. 8

An example of search results generated by the process described with reference to FIG. 6 is shown in FIG. 8. A series of search results which have been refined in accordance with procedures described with reference to FIG. 6 are displayed at 801 to the initiating consumer.

1. A method of graphically representing a personal profile for a consumer, comprising the steps of:
identifying a plurality of categories, in which a major variable representing the appropriateness for said consumer of each said category may be given a numerical value; allocating a colored block for each of said categories, wherein each allocated color is defined by three color variables;
modifying one of said color variables in response to the numerical value of the respective major variable; and
arranging said colored blocks on at least one axis with respect to how the categories are measured against an attribute.

2. A method according to claim 1, wherein said color variables are hue, saturation and luminosity.

3. A method according to claim 2, wherein said color variable that is modified in response to the numerical value of the respective major variable is hue.

4. A method according to claim 1, wherein said colored blocks are arranged in fields, representing the arrangement of categories into fields.

5. A method according to claim 1, comprising the further steps of:
identifying a minor variable representing the appropriateness for said consumer of each said category, that may be given a numerical value; and
modifying one of said color variables in response to the numerical value of the respective minor variable.

6. A method of defining a peer group of consumers, comprising the steps of:
identifying a plurality of categories, in which a major variable representing the appropriateness for said consumer of each said category may be given a numerical value;
populating said numerical values based on consumer preferences and recorded activities to produce a consumer profile;
comparing a plurality of consumer profiles with respect to predefined tolerances; and
grouping consumers into peer groups in response to said comparisons.

7. A method according to claim 6, wherein said consumer preferences are obtained by registration or other requested input from a consumer.

8. A method according to claim 6, wherein said recorded activities include web history information.

9. A method according to claim 6, wherein said step of comparing a plurality of consumer profiles with respect to predefined tolerances includes comparing consumer profiles to a specified model profile.

10. A method according to claim 6, wherein said step of grouping consumers into peer groups in response to said comparisons includes grouping together consumers with profiles that are similar.

11. A method according to claim 6, wherein said consumer is allocated to more than one peer group.

12. A method according to claim 11, wherein said consumer is allocated to different peer groups for categories which fall within different fields.

13. A method according to claim 11, wherein said consumer is allocated to different peer groups which are subsets of each other.

14. A method of conducting an online search, comprising the steps of:
receiving a search string from an initiating consumer;
directing said search string towards one or more commercially funded search engines to produce provisional search results;
comparing said provisional search results with respect to peer preference data to produce refined results; and
supplying said refined results to said initiating consumer.

15. A method according to claim 14, wherein said peer preference data is obtained from a peer group defined in according with claim 6.

16. A method according to claim 14, further comprising the step of removing paid results from said provisional search results.

17. A method according to claim 14, wherein said peer preference data includes experiences of members of a peer group of said initiating consumer.

18. A method according to claim 17, wherein a weighted average of the experiences of peer group members is used.

19. A method according to claim 18, wherein peer group members more closely related to said initiating consumer have a greater influence over said refined results.

20. A method according to claim 14, wherein said peer preference data includes preferences explicitly provided by members of a peer group of said initiating consumer.
